(19) United States
(12) Patent Application Publication
(10) Pub. No.: US 2011/0049816 A1
(43) Pub. Date: Mar. 3, 2011

(54) Quick connecting device structure

(75) Inventor: Chung-Liang Hsu, Taiping City (TW)

(73) Assignee: Chung Jaan Industrial Co., Ltd.

(21) Appl. No.: 11/822,148

(22) Filed: Jul. 2, 2007

(51) Int. Cl. B23B 31/107

(52) U.S. Cl. 279/30

(57) ABSTRACT

A quick connecting device structure comprises a shaft body defined by a proper-length external ring guiding section with two restricting surfaces for the abutment of front and rear movement rings to clamp a spring element there-between. The shaft body also includes a storing socket with an external assembly portion at one end, and an extensible bore drilled at the other end for the accommodation of a steel ball. A cylindrical sleeve has an end defined by an internal stepwise abutment ringed surface and a coupling cavity, and the other end having first and second annular insert grooves. A stop collar fitted to the coupling cavity provides another abutment ringed surface. The two abutment ringed surfaces can bi-directionally press at the front or rear movement ring with the spring element respectively, forming a two-way pressing-and-bouncing operation. Thus, a driver shank can be easily slid in/out for quick installment or replacement thereof.

### BACKGROUND OF THE INVENTION

The present invention relates to a quick connecting device structure, comprising a shaft body, a set of front and rear movement rings, a spring element, a stop collar and a cylindrical sleeve wherein the cylindrical sleeve operates in counterforce with an assembly portion of the shaft body, and the stop collar and the internal surface of the cylindrical sleeve are respectively equipped with an abutment ringed surface which can bi-directionally press against the front or rear movement ring along with the spring element, forming a two-way pressing-and-bouncing operation so that a driver shank can be easily slid in or out for quick installment or replacement thereof.

Please refer to FIGS. 1, 2. A conventional connector 20 applied to couple with a driver shank 10 is equipped with a shaft body 21 having an extensible bore 211 drilled through at the outer periphery thereon for the accommodation of a steel ball 22 therein. The shaft body 21 also includes a fixed stop flange 212 extending at the outer circumference to which a spring 23 is mounted thereon. A cylindrical sleeve 24 defined by an indented oblique surface 241 is fitted to the shaft body 21 to abut against the stop flange 212 thereof. When a driver shank 10 defined by a ringed groove 101 thereon is to be inserted into the connector 20, the cylindrical sleeve 24 is squeezed by force to compress the single spring 23, permitting the steel ball 22 to accommodate into the indented oblique surface 241 so that the driver shank 10 can be slid inwards in a second. Then, the spring 23 will automatically rebound, actuating the steel ball 22 to return into the extensible bore 211 and insert to the ringed groove 101 for location of the driver shank 10 thereby. However, the spring 23 pressing in one-way direction is utilized and the cylindrical sleeve 24 must be constantly pushed so as to mount the driver shank 10 thereto. As a result, the cylindrical sleeve 24 must be repeatedly pressed so as to release the driver shank 10 there-from for withdrawal or replacement purpose thereof. Thus, the conventional connector 20 thereof fails to provide an easy and fast change of the driver shank 10, which makes it uncompetitive on the market.

### SUMMARY OF THE PRESENT INVENTION

It is, therefore, the primary purpose of the present invention to provide a quick connecting device structure, comprising a shaft body, a set of front and rear movement rings, a spring element, a stop collar and a cylindrical sleeve wherein the stop collar and the internal surface of the cylindrical sleeve are respectively equipped with an abutment ringed surface which can bi-directionally press against the front or rear movement ring along with the spring element to slide inwards or outwards and abut against either restricting surface defining both end edges of a ring guide section of the shaft body so that a steel ball can be accommodated into a first or a second annular insert groove of the cylindrical sleeve, and, thus, a driver shank having a ringed groove without being restricted by the steel ball can be easily slid in or out the connecting device for quick installment or replacement purpose thereof.

It is, therefore, the second purpose of the present invention to provide a quick connecting device structure wherein the cylindrical sleeve operates in counterforce with an assembly portion of the shaft body, and the front and rear movement rings are respectively pressed by one abutment ringed surface to form a bi-directional pressing-and-bouncing operation; whereby the driver shank can be easily and firmly installed without the cylindrical sleeve being repeatedly pressed, providing a convenient and quick connecting device thereby.

### BRIEF DESCRIPTION OF THE DRAWINGS

FIG. 1 is a cross sectional view of a conventional connector.

FIG. 2 is a cross sectional view of the conventional connector in application.

FIG. 3 is an exploded perspective view of the present invention.

FIG. 4 is an assembled perspective view of the present invention.

FIG. 5 is an assembled cross sectional view of the present invention.

FIG. 6 is a diagram showing the operation of a driver shank mounted into the present invention.

FIG. 7 is another diagram showing the operation of the driver shank mounted into the present invention.

FIG. 8 is a third diagram showing the operation of the driver shank mounted into the present invention.

FIG. 9 is a diagram showing the operation of the driver shank releasing from the present invention.

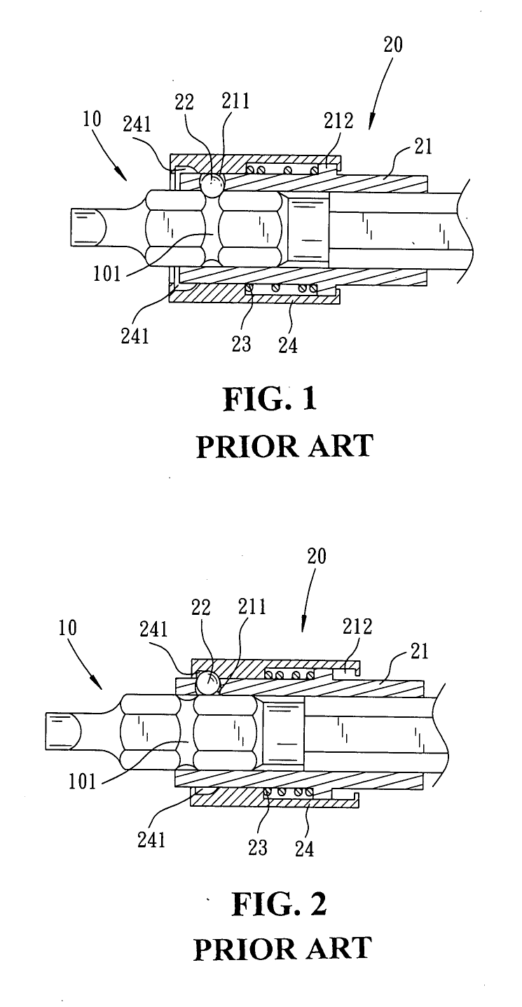

### DETAILED DESCRIPTION OF THE PREFERRED EMBODIMENTS

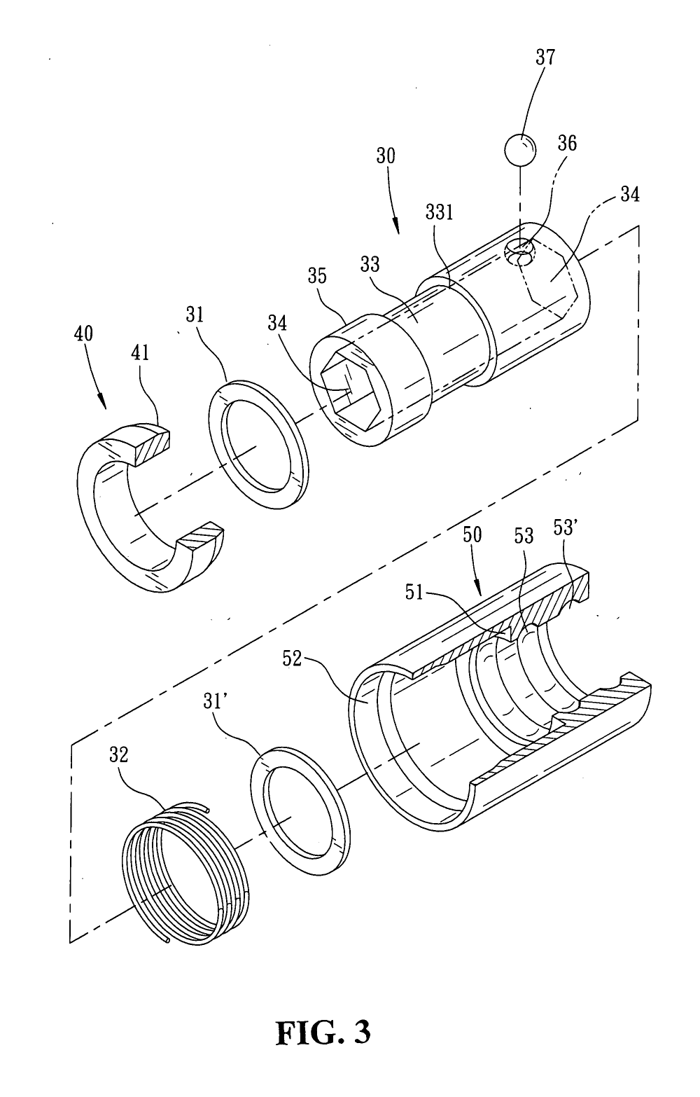

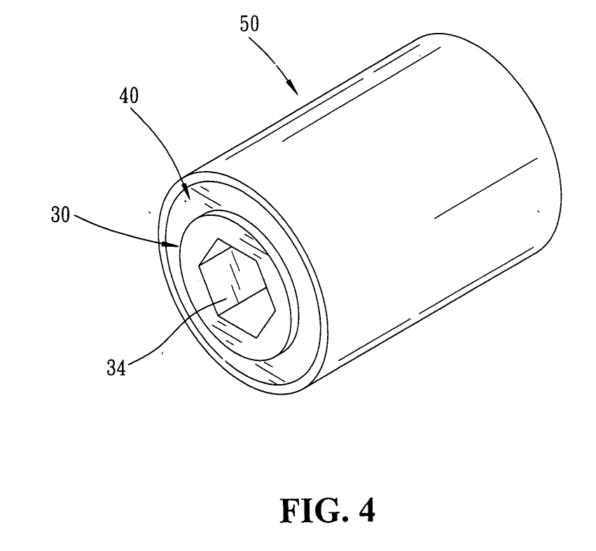

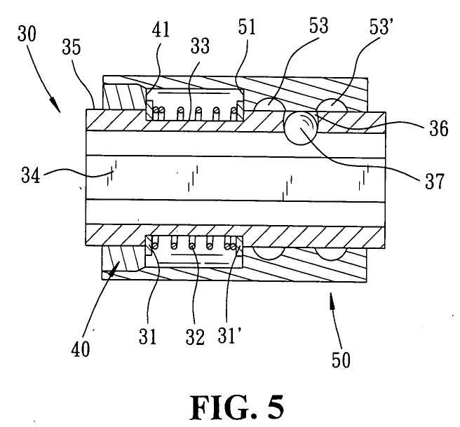

Please refer to FIG. 3 showing an exploded perspective view of the present invention (accompanied by FIGS. 4 to 5 inclusive). The present invention relates to a quick connecting device structure, comprising a shaft body 30, a set of front and rear movement rings 31, 31′, a spring element 32, a stop collar 40, and a cylindrical sleeve 50. The shaft body 30 has a proper-length ring guiding section 33 defining the appropriate position of the outer periphery thereon, and both end edges of the ring guiding section 33 have a restricting surface 331 defining thereon respectively to which both front and rear movement rings 31, 31′ are mounted and abutted thereby. Meanwhile, the spring element 32 is mounted between the front and rear movement rings 31, 31′. The shaft body 30 has the internal surface defined by a hexagonal-shaped storing socket 34 therein, and the external periphery of one end equipped with an assembling portion 35 to which the stop collar 40 having an inner diameter slightly larger than the outer diameter of the assembly portion 35 is mounted thereon. The cylindrical sleeve 50 has the internal surface of one end defined by a stepwise abutment ringed surface 51, and a coupling cavity 52 indented at the opening edge to which the stop collar 40 is precisely joined at the outer periphery and squeezed tight thereto to form another abutment ringed surface 41 thereby. The cylindrical sleeve 50 has the internal surface of the other end defined by a pair of appropriate-depth first and second annular insert grooves 53, 53′ to mount to one end of the shaft body 30 having an extensible bore 36 drilled at the external periphery thereon. The extensible bore 36 is molded into an arched annular shape to house a steel ball 37 therein and form an accommodation space thereby. Therefore, the cylindrical sleeve 50 can be bi-directionally pushed to actuate the two abutment ringed surfaces 41, 51 respectively, squeezing at the front or the rear movement ring 31, 31′ along with the spring element 32 to form a two-way pressing-and-bouncing operation thereby.

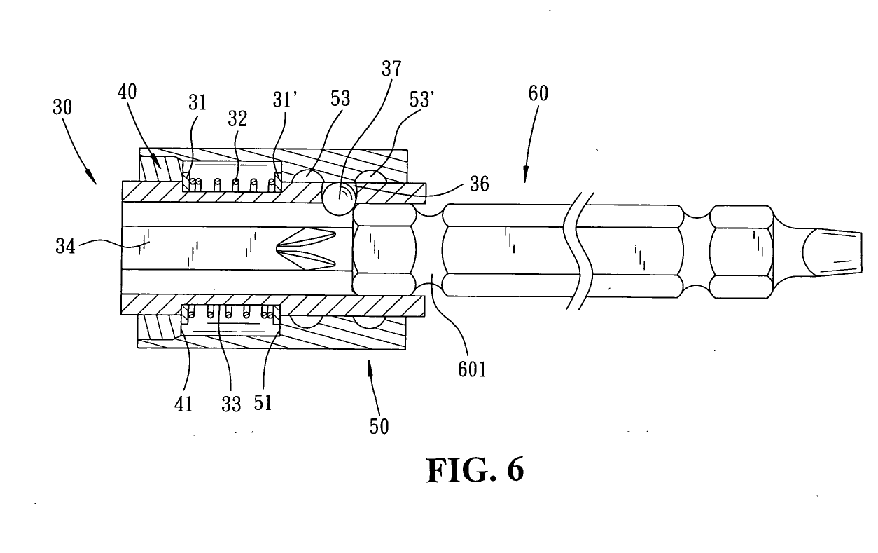

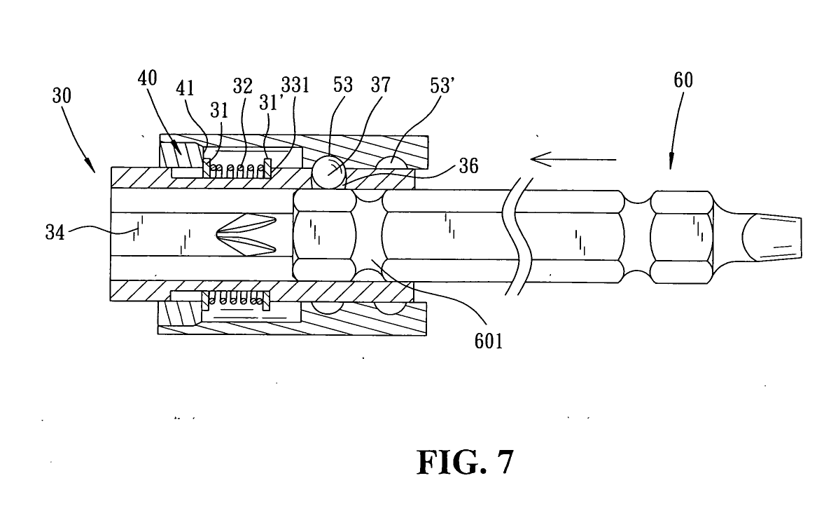

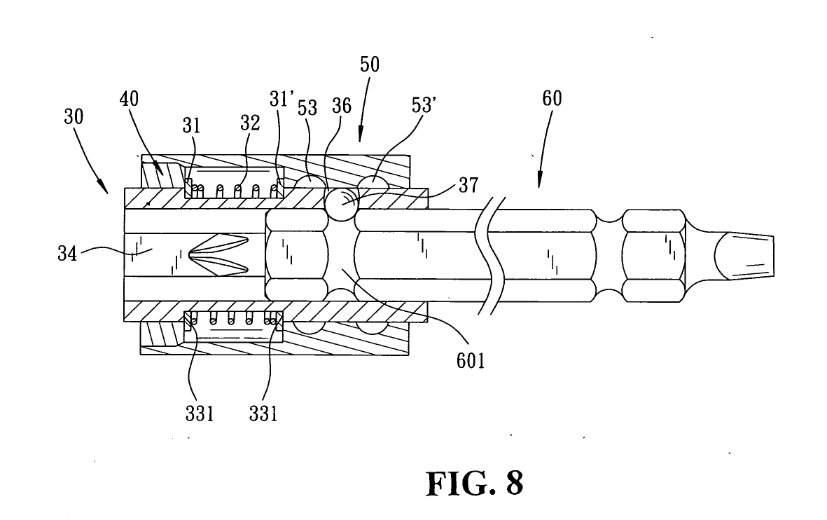

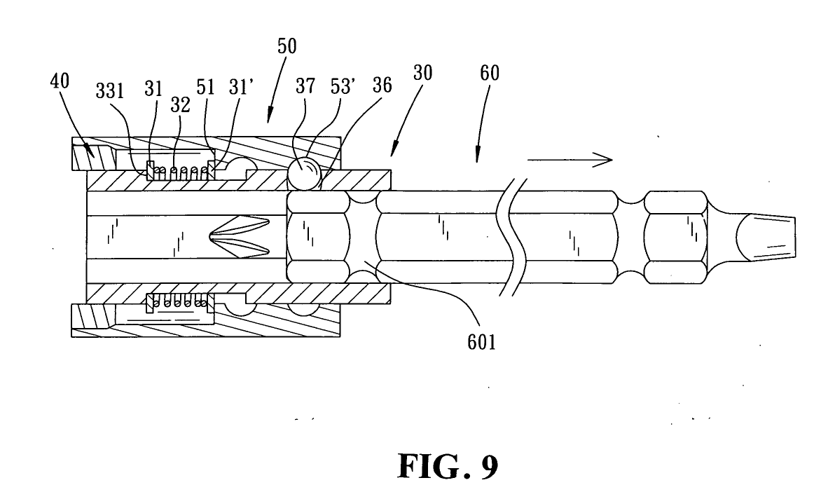

Please refer to FIGS. 6 to 8 inclusive. To install a driver shank 60 (like a double-end driver), the driver shank 50 is directly forced into the storing socket 34 of the shaft body 30, permitting the cylindrical sleeve 50 to operate in counterforce with the assembly portion 35 thereof. Then, the abutment ringed surface 41 of the stop collar 40 will push against the front movement ring 31, squeezing at the spring element 32 and the rear movement ring 31′ to abut at one side against the restricting surface 331 extending at one side thereon. Meanwhile, the first annular insert groove 53 is matched to the extensible bore 36, permitting the steel ball 37 to precisely accommodate into the first annular insert groove 53 therein. Thus, the driver shank 60 having a ringed groove 601 defining thereon will be released from the restriction of the steel ball 37 to slide into the storing socket 34 in a second. Then, via the rebound of the spring element 32, the front movement ring 31 is allowed to automatically bounce backwards to abut against the restricting surface 331 extending at the other side thereon. Meanwhile, the steel ball 37 will be relocated back to the extensible bore 36 and firmly fitted into the ringed groove 601 for stable location thereby, completing the installment of the driver shank 60. To change or release the driver shank 60 thereof, the driver shank 60 is directly withdrawn to form a counterforce with the assembly portion 35 thereby. The abutment ringed surface 51 extending at the internal wall of the cylindrical sleeve 50 will press against the rear movement ring 31′ and squeeze at one side of the spring element 32, permitting the steel ball 37 to precisely fit into the second annular insert groove 53′ thereby. Then, the ringed groove 601 of the driver shank 60 can be released from the restriction of the steel ball 37 and the driver shank 60 can be smoothly withdrawn thereby as shown in FIG. 9. Therefore, the driver shank 60 can be bi-directionally slid in or out the connecting device without the cylindrical sleeve 50 being repeatedly pressed for easy installment or replacement thereof, achieving a convenient and quick connecting device structure thereby.

What is claimed is:

1. A quick connecting device structure, comprising a shaft body, a set of front and rear movement rings, a spring element, a stop collar, and a cylindrical sleeve wherein the shaft body has a proper-length ring guiding section defining the appropriate position of the outer periphery thereon, and both end edges of the ring guiding section have a restricting surface extending thereon respectively to which both front and rear movement rings are mounted to clamp the spring element there-between; the shaft body also includes a storing socket defining the internal surface thereon, an assembling portion extending at the outer periphery of one end, and an extensible bore drilled at the outer periphery of the other end for the accommodation of a steel ball therein; the cylindrical sleeve has the internal surface of one end defined by a stepwise abutment ringed surface and a coupling cavity, and the other end internal surface defined by a pair of appropriate-depth first and second annular insert grooves; then, the cylindrical sleeve and the shaft body are reciprocally fitted to each other, permitting the coupling cavity of the cylindrical sleeve to abut tight against the outer periphery of the stop collar and form another abutment ringed surface thereby; whereby, due to the cylindrical sleeve operating in counterforce with the assembly portion of the shaft body, the two abutment ringed surfaces thereof can bi-directionally press at the front or rear movement ring respectively and compress the spring element to form two-way pressing-and-bouncing operation thereby; therefore, a driver shank can be bi-directionally slid in or out for easy and fast installment or replacement thereof, achieving a quick connecting device structure thereby.

2. The quick connecting device structure as claimed in claim 1 wherein the storing socket of the shaft body has the internal surface molded into a hexagonal-shaped hole.

3. The quick connecting device structure as claimed in claim 1 wherein the inner diameter of the stop collar is slightly larger than the outer diameter of the assembly portion of the shaft body thereof.

4. The quick connecting device structure as claimed in claim 1 wherein the extensible bore can be molded into an arched annular shape.
